(19) United States
(12) Patent Application Publication
(10) Pub. No.: US 2018/0232971 A1
(43) Pub. Date: Aug. 16, 2018

(54) Systems And Methods For Managing Access To A Vehicle Or Other Object Using Environmental Data

(71) Applicant: Microchip Technology Incorporated, Chandler, AZ (US)

(72) Inventors: Pieter Schieke, Phoenix, AZ (US); Vivien Delport, Fountain Hills, AZ (US)

(73) Assignee: Microchip Technology Incorporated, Chandler, AZ (US)

(21) Appl. No.: 15/892,737

(22) Filed: Feb. 9, 2018

Related U.S. Application Data
(60) Provisional application No. 62/457,221, filed on Feb. 10, 2017.

(51) Int. Cl. G07C 9/00; H04W 12/06; H04W 12/08; H04L 9/32; H04W 12/04; H04L 9/08

(52) U.S. Cl. CPC G07C 9/00007; H04W 12/06; H04W 12/08; H04L 9/3271; H04W 12/04; G07C 2009/00412; G07C 9/00309; H04L 2209/80; H04L 2209/84; G07C 2009/00388; G07C 2009/00769; H04L 9/0838

(57) ABSTRACT

Systems and methods for controlling access to a vehicle or other object are provided. A vehicle-based authentication unit and mobile access device, e.g., a key fob, that wirelessly communicates with the vehicle-based authentication unit may each include environmental sensor(s) that collect respective environmental data local to the respective device/unit, e.g., GPS data, local temperature data, local barometric pressure data, etc. The mobile access device transmits an access request message (e.g., a response to a challenge from the vehicle-based authentication unit) that includes environmental data collected by the onboard sensor(s). The vehicle-based authentication unit receives the access request message and determines whether to grant access to the vehicle based on the environmental data included in the message. For example, the authentication unit may compare the environmental data in the access request message with corresponding environmental data collected by sensor(s) at the vehicle, or with other reference data (e.g., user-specific fingerprint data).

### RELATED PATENT APPLICATION

This application claims priority to commonly owned U.S. Provisional Patent Application No. 62/457,221, filed Feb. 10, 2017, which is hereby incorporated by reference herein for all purposes.

### TECHNICAL FIELD

The present disclosure relates to managing access to vehicles or other objects, and more particularly, to system and methods for managing access to a vehicle or other object using detected or collected environmental data.

### BACKGROUND

Various systems and techniques exist for managing access to a protected object, e.g., a vehicle, a house, other possession, data, or any other type of object. For example, some vehicle access systems include a wireless authenticated access system that allows a user to lock and unlock a vehicle using a special key fob or other small mobile access device, based on wireless communications between the mobile access device and an authentication unit provided in the vehicle.

However, such systems may suffer from various security limitations or weaknesses. For example, when a receiver in a wireless authenticated access system receives an encrypted data transmission, it may be unable to fully confirm that the transmission is intentional or is generated by unauthorized action. Thus, some systems allow for a “relay attack,” whereby a data transmission is captured and then replayed over a distance to unlock a protected object (e.g., vehicle or house) while the owner is not aware. Some systems allow for “capture and replay” attacks, in which a transmission is captured and re-transmitted later to illegally get access to a protected object. In this case, the original data transmission may have been legitimate, but the replay may be spoofed an unauthorized.

FIG. 1 shows an example of a conventional wireless authenticated access system 10 for managing access to a vehicle 20 via wireless communications between a mobile access device (e.g., key fob) 14 carried by an authorized user and a vehicle-side authentication unit 12. In this system, vehicle-side authentication unit 12 may generate and wirelessly transmit an authentication challenge upon detecting an access triggering event. The access triggering event could include a person touching a door handle or other part of the vehicle, or authentication unit 12 wirelessly detecting a nearby presence of mobile access device 14 (e.g., using radio-frequency identification (RFID), near-field communication (NFC), or other communication technology), for example. The authentication challenge may include a randomly generated number. Authentication unit 12 may transmit the authentication challenge via low frequency (LF) radio waves, e.g., at 125 kHz.

Mobile access device (e.g., key fob) 14 may wirelessly receive the authentication challenge, calculate a challenge response, and wirelessly communicate the challenge response to the vehicle-side authentication unit 12. Mobile access device 14 may calculate the challenge response by encrypting the random number in the authentication challenge using a shared key 30, which is known to both mobile access device 14 and vehicle-side authentication unit 12. Mobile access device 14 may transmit the challenge response via short-range RF, e.g., at 315 MHz.

Authentication unit 12 may wirelessly receive the challenge response transmitted by mobile access device 14, decrypt the challenge response using the shared key 30, and compare the decrypted challenge response with the authentication challenge, e.g., by checking whether the decrypted message includes the random number from the authentication challenge. If the response matches the authentication challenge, authentication unit 12 may unlock the vehicle door(s) or otherwise provide access to the vehicle or to some function of the vehicle. If not, authentication unit 12 may ignore the challenge response, or alternatively, may output a notification indicating a failed access attempt.

FIG. 2 shows a conventional process 100 for managing authentication-based access to vehicle 20 using the conventional wireless authenticated access system 10 shown in FIG. 1. Authentication unit 12 may detect an access triggering event and generate an authentication challenge (e.g., including a random number) at 102, and wirelessly transmit the authentication challenge at 104. At 106, mobile access device (e.g., key fob) 14 wirelessly receives the authentication challenge, and calculates a challenge response including the random number encrypted using a shared key 30. Mobile access device 14 wirelessly transmits the challenge response at 108. In parallel, authentication unit 12 also calculates a response to its authentication challenge, by encrypting the random number using the shared key 30.

At 112, authentication unit 12 receives the encrypted challenge response from mobile access device 14, and determines whether the encrypted challenge response matches the encrypted response calculated at 110. If the challenge response is a match, authentication unit 12 may unlock the vehicle door(s) or otherwise provide access to the vehicle. If not, authentication unit 12 may ignore the challenge response or generate a failed access notification, as discussed above. As a functionally similar alternative to steps 110 and 112, authentication unit 12 may use the shared key 30 to decrypt the encrypted challenge response received from mobile access device 14, and determine whether the unencrypted response includes the random number from the challenge.

FIG. 3 shows an example “relay attack” process 200 allowing an unauthorized party to obtain access to vehicle 20 using a conventional system 10 as shown in FIG. 1 or 2. A relay attack may be performed using a two-part relay attack system 50 that includes a first relay device (“Relay A” device) 52 positioned near vehicle 20 and a second relay device (“Relay B” device) 54 positioned near an authorized mobile access device (e.g., key fob) 14, which may be substantially remote from vehicle 20. Relay A device 52 and Relay B device 54 may be carried by two individuals working together for the attack. Relay A device 52 and Relay B device 54 R may communicate with each other via a different communication frequency or channel than those used by authentication unit 12 and mobile access device 14. For example, Relay A device 52 and Relay B device 54 may communicate via 2.56 GHz RF.

To begin the attack, the individual carrying Relay A device 52 may trigger vehicle-side authentication unit 20 to generate and transmit an authentication challenge at 202, e.g., by touching a door handle. Relay A device 52 may capture and relay the authentication challenge to remotely-located Relay B device 54 at 204. Relay B device 54 may further relay the authentication challenge to mobile access device 14 at 206, e.g., using the same transmission frequency used by authentication unit 12, e.g., 125 kHz in this example. Mobile access device 14, believing it has received a validly-triggered authentication challenge from vehicle-side authentication unit 20, generates and transmits a challenge response at 208. Relay B device 54 may then capture and relay the challenge response to remotely-located Relay A device 52 at 210. Relay A device 52 may further relay the challenge response to vehicle-side authentication unit 20 at 212, e.g., using the transmission frequency used by mobile access device 14. Authentication unit 20, believing it has received a challenge response from a nearby mobile access device, checks and authenticates the challenge response, and generates an access command (e.g., door unlock) at 214, thereby allowing the individual carrying Relay A box 52 to enter or access the vehicle.

FIG. 4 shows an example “capture and replay attack” process 300 allowing an unauthorized party to obtain access to vehicle 20 using a conventional system 10 as shown in FIG. 1 or 2. A capture and replay attack may be performed using an attacker device 60 configured to capture transmissions from a mobile access device (e.g., key fob) and transmit an access request to a vehicle-based authentication unit 12 at a later time to gain access to the vehicle. In addition, attacker device 60 may be configured to transmit signals that jam or block RF communications between mobile access device 14 and vehicle-side authentication unit 12. Such jamming or blocking signals may prevent authentication unit 12 from responding to a transmission from mobile access device 14, thereby forcing the user to re-transmit multiple access request attempts, allowing attacker device 60 to capture the re-transmit such messages them. Such techniques may be employed in a code-hopping transmission system, for example.

In the illustrated example, when a mobile access device 14 transmits an access request (e.g., a challenge response or other access-related message) to authentication unit 20 at 302A, attacker device 60 may also capture this transmission at 302B. Attacker device 60 may store and/or analyze the captured transmission from mobile access device 14, and later use the captured transmission for generating and transmitting a spoofed access request to authentication unit 12, to generate an access command 308 for gaining unauthorized access to vehicle 20.

### SUMMARY

Embodiments of the present disclosure are directed to wireless authenticated access systems and method for managing access to an object (e.g., vehicle, house, data, etc.) based on an evaluation of relevant environmental data collected by one or more environmental data sensors, e.g., GPS data, temperature data, humidity data, barometric pressure data, fingerprint data, etc. Some embodiments provide systems and method that utilize encryption and/or decryption of environmental data or encryption and/or decryption of data (e.g., a challenge response) using environmental data for an access authentication evaluation.

Such systems may be embedded in electronic devices and may improve operation of the electronic devices by making the electronic devices more secure. Some embodiments may incorporate environmental data into existing systems or devices, e.g., KeeLoq electronic devices. These may include a hardware-dedicated block cipher utilizing a non-linear feedback shift register (NLFSR). Thus, some embodiments may be implemented using digital circuitry, analog circuitry, or a suitable combination thereof. Other embodiments may be implemented by instructions in computer-readable medium which, when loaded and executed by a processor, cause the processor to perform the operations and functionality described in the present disclosure.

Some embodiments may add additional security to any Identify Friend or Foe (IFF) system. By adding environmental data to communication between devices, the system may ensure the generation of unique communication between systems as the environmental variables may be unique. Further, additional unique variables may be used, such as personal variables. The combination of these may lead to still higher levels of security in the resulting schemes.

In some embodiments, environmental data (e.g., GPS coordinates, temperature, position or orientation of the transmitter, humidity, barometric pressure, altitude above sea-level, etc.) can be used to encrypt particular transmissions involved in a wireless access authentication process. Such encryption may use the environmental data as, for example, a nonce, shared secret, or a private key. In some embodiments, environmental data may include personal data, e.g., heart rate, temperature, blood oxygen content, fingerprint data, etc., which may be transmitted and utilized in the access authentication process. A receiver (e.g., at a vehicle-side authentication unit) can then make decisions as to whether the received transmission is valid based on algorithms programmed into it. Any suitable encryption engines may be used.

Embodiments disclosed herein may be configured to defeat a “relay attack,” a “capture and replay” attack, and various other types of attacks.

In one embodiment, the ambient temperature may be used as a variable or parameter to encrypt the transmission of data to the vehicle. The ambient temperature may be taken an instant measurement. When the vehicle receives the request, it may be verified or decrypted in part using the vehicle's own instant measurement of temperature. In such a case, without the ambient temperature, the transmission cannot be decrypted by a man-in-the-middle. Moreover, a thief or hacker cannot spoof the transmission because the thief or hacker cannot correctly encrypt the request as expected by the vehicle. The use of temperature may be concealed from the public as part of the encryption scheme. The use of GPS coordinates may be similarly used. A thief or hacker, working remotely, might not know the GPS value to attempt to use.

In another embodiment, the ambient temperature may be transmitted as part of the transmission from the remote access device to the vehicle. When the vehicle receives the transmission, it may check the transmitted temperature included in the transmission against its own instant measurement of temperature. If the temperatures match (e.g. with less than a specified difference between the temperatures, or according to any other matching criteria), then the request may be authenticated. The use of GPS coordinates may be similarly used. If the GPS request from the remote entry is not from a location that is sufficiently close to the GPS coordinate generated by the vehicle, then the request may be denied. A thief or hacker, working remotely, might not know the GPS value to attempt to use.

Moreover, values of temperature, location, or other personal data or environmental data may be scrambled. For example, temperatures might not be directly used to encrypt data, but instead a modified temperature is used, wherein the temperature is modified or multiplied times a date, another environmental variable, a sliding scale varying by date, or by a shared secret. Both the remote access device and the vehicle may know what modifications to make to the environmental or personal variable. Furthermore, the system may switch between multiple types of environmental data to use over time. The selection of which type of environmental data to use at a particular time may be a shared secret between the vehicle and the mobile access device. A thief or hacker might not know what values to use, even if the actual values could be determined.

Adding environmental or personalization elements into the data transmission may reduce the feasibility of reuse for illegal purposes. In addition to the normal encryption, to obscure the content of the transmission, the system may include additional situational information in the encrypted data that can be checked afterwards. The receiver can perform a series of “sanity checks” on the transmission to help identify a legal/authorized transmission. For example, GPS coordinates of the transmitter may be included at the time of transmission. If the transmission is illegally/illegitimately relayed, the GPS coordinates of the transmitter will not be within an allowed range from the receiver's GPS coordinates. The transmission may be deemed illegally/illegitimately relayed if the environmental temperature is different between the transmitter and the receiver. In some embodiments, the mobile access device may include a fingerprint sensor that adds digital data from the fingerprint in the transmission to further authenticate an access request.

### BRIEF DESCRIPTION OF THE FIGURES

Example aspects and embodiments are discussed below with reference to the drawings, in which:

FIG. 1 shows a conventional process for managing authentication-based access to a vehicle via wireless communications between a mobile access device (e.g., key fob) and a vehicle-side authentication unit;

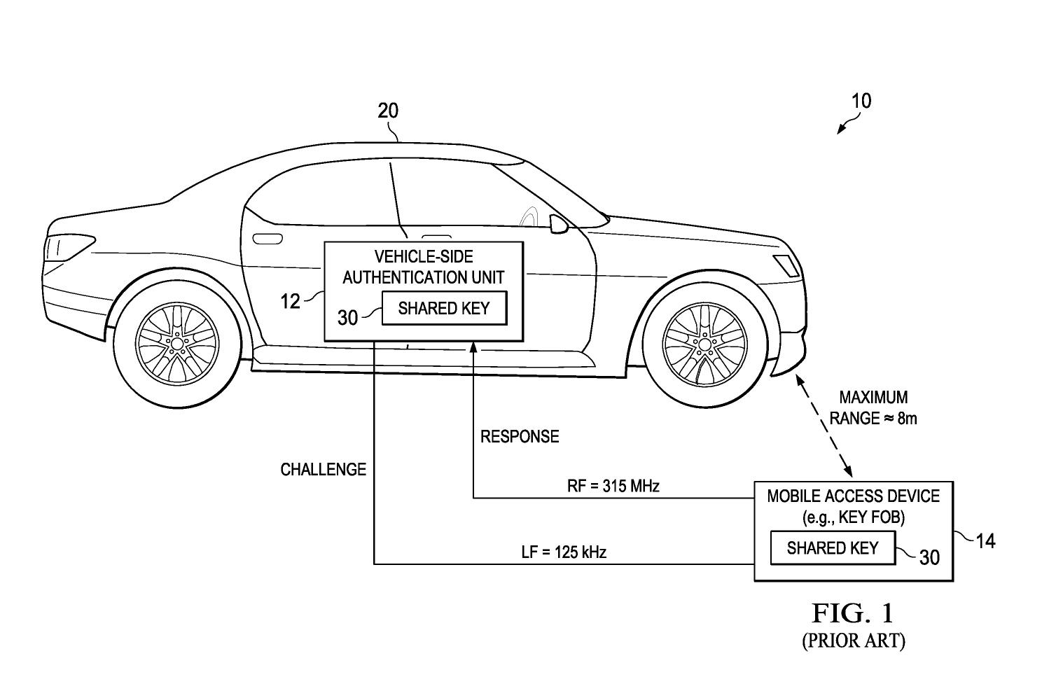

FIG. 2 shows a conventional process for managing authentication-based access to a vehicle via an encrypted challenge-response exchange between a mobile access device (e.g., key fob) and a vehicle-side authentication unit;

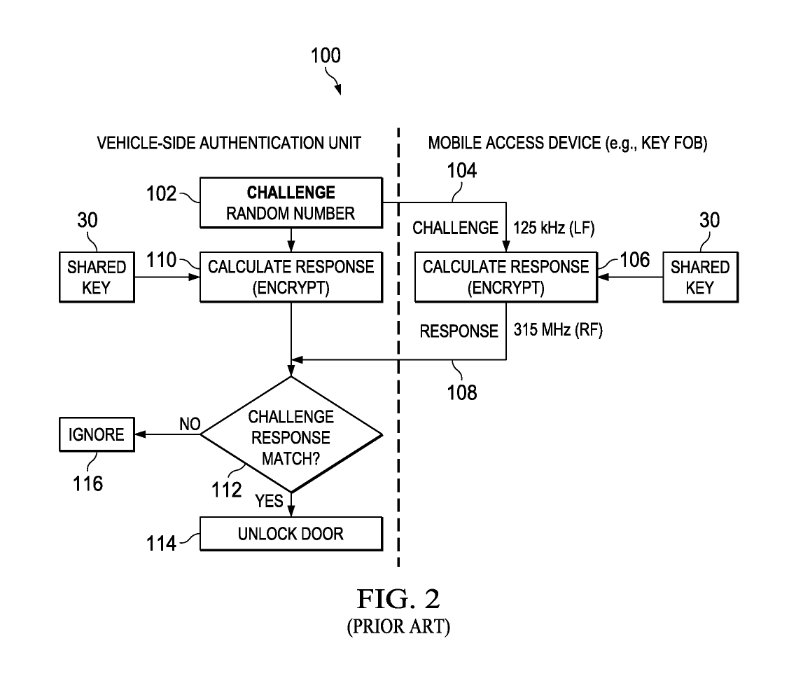

FIG. 3 shows an example “relay attack” allowing an unauthorized party to obtain access to a vehicle using a conventional system as shown in FIG. 1 or 2;

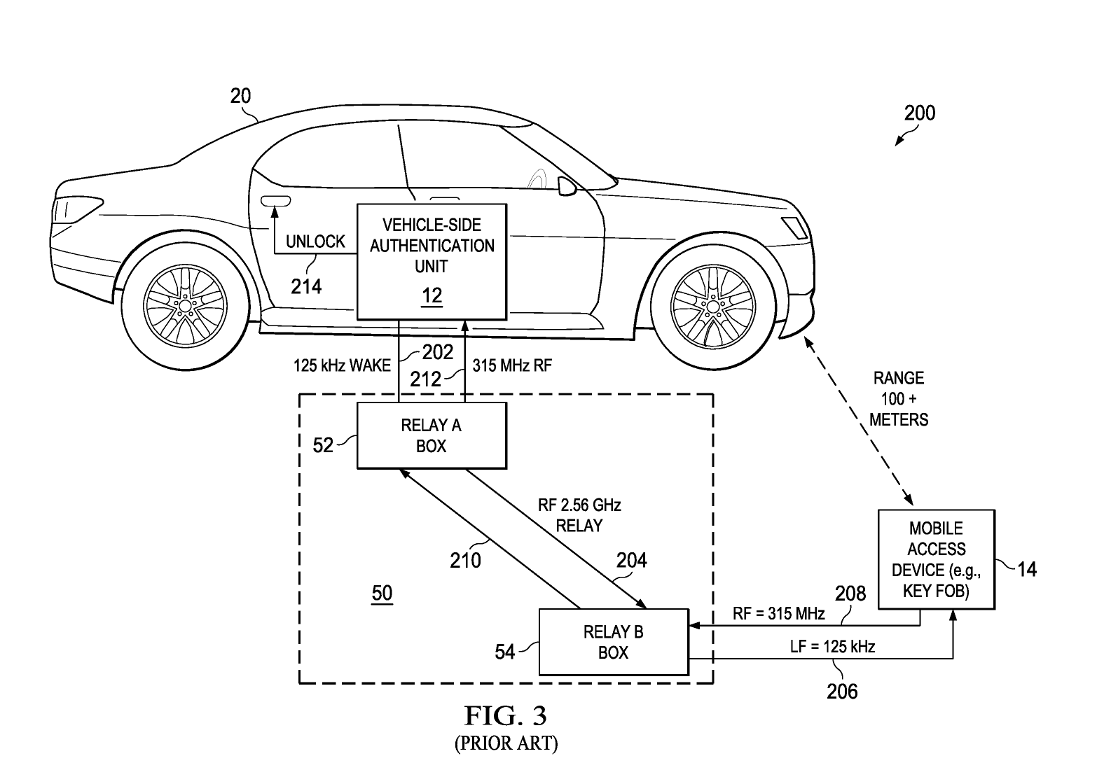

FIG. 4 shows an example “capture and replay attack” allowing an unauthorized party to obtain access to a vehicle using a conventional system as shown in FIG. 1 or 2;

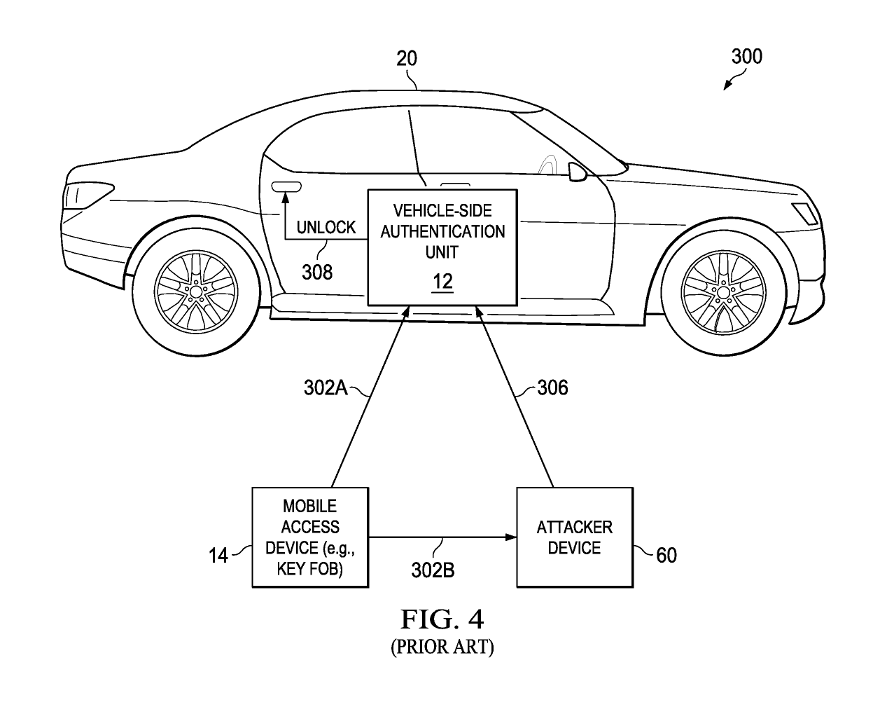

FIG. 5 shows an example system for managing authentication-based access to a vehicle using sensor-based environmental data, according to example embodiments of the present disclosure;

FIG. 6 is a flowchart showing a first example process for managing authentication-based access to a vehicle using sensor-based environmental data, according to one example embodiment; and

FIG. 7 is a flowchart showing a second example process for managing authentication-based access to a vehicle using sensor-based environmental data, according to another example embodiment.

### DETAILED DESCRIPTION

As discussed above, embodiments of the present disclosure are directed to wireless authenticated access systems and method for managing access to an object (e.g., vehicle, house, data, etc.) based on an evaluation of relevant environmental data collected by one or more environmental data sensors, e.g., GPS data, temperature data, humidity data, barometric pressure data, fingerprint data, etc. As shown below, some embodiments provide systems and method that utilize encryption and/or decryption of environmental data or encryption and/or decryption of data (e.g., a challenge response) using environmental data for an access authentication evaluation.

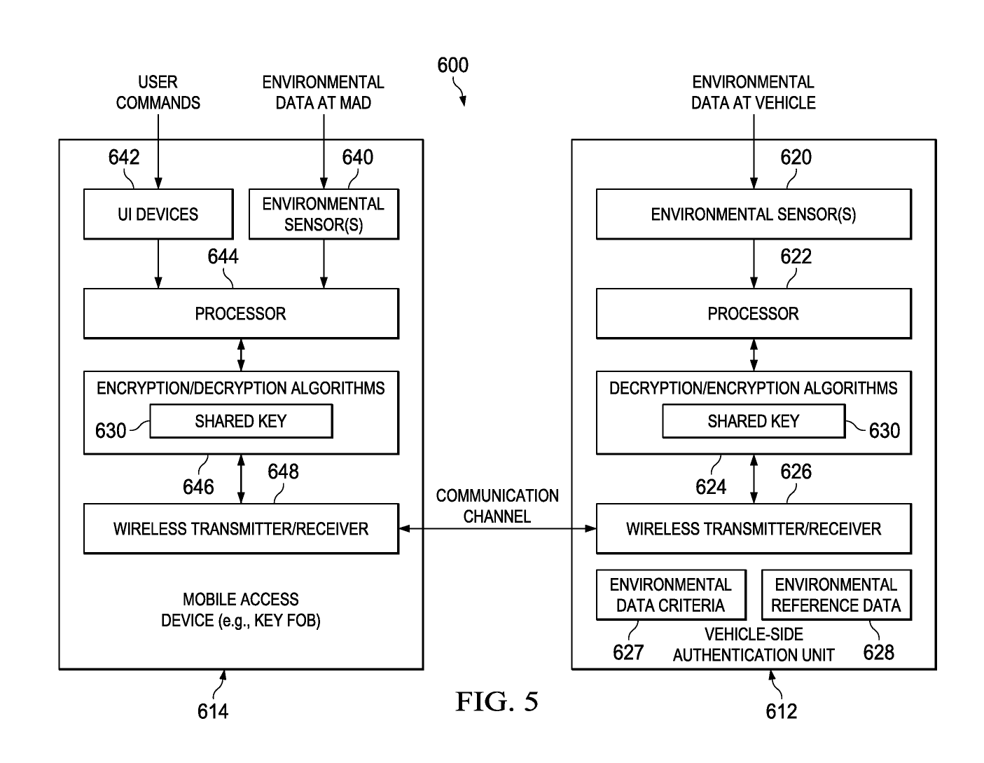

FIG. 5 shows an example system 600 for managing authentication-based access to a vehicle using sensor-based environmental data, according to example embodiments of the present disclosure. System 600 may include a vehicle-side authentication unit 612 and a mobile access device (e.g., key fob) 614 configured to wirelessly communicate with each other, e.g., via radio communications (e.g., using LF and/or RF frequencies).

As shown, vehicle-side authentication unit 612 may include one or multiple vehicle-side environmental sensors 620, a processor 622, decryption/encryption circuitry 624, wireless communication interfaces 626, environmental data criteria 627, and environmental reference data 628.

A vehicle-side environmental sensor 620 may include any type of sensor, device, or system configured to collect or detect vehicle-side environmental data. As used herein, “vehicle-side environmental data” includes any data regarding one or more characteristic of the status or environment of vehicle 20 or vehicle-side authentication unit 612. For example, vehicle-side environmental sensors 620 may include any one or more of the following types of sensors, devices, or systems (and one or more instance of each type) configured to collect or detect any of the following types of vehicle-side environmental data:
(a) a global positioning system (GPS) system or other geographic location system configured to determine geographic coordinates or other geographic location data regarding the vehicle or authentication unit 612,
(b) an altimeter configured to measure an altitude of the vehicle or authentication unit 612,
(c) a temperature sensor configured to measure local temperature data at the vehicle or authentication unit 612,
(d) a humidity sensor configured to measure local humidity data at the vehicle or authentication unit 612,
(e) a pressure sensor configured to measure local barometric pressure data at the vehicle or authentication unit 612,
(f) any other type(s) of sensors, devices, or systems configured to detect or collect data regarding one or more characteristic of the status or environment of vehicle 20 or vehicle-side authentication unit 612.

Processor 622 may include a microprocessor, a microcontroller including a microprocessor, an application processor, a digital signal processor, or any other type of data processing device. Decryption/encryption circuitry 624 may include any known or suitable decryption and/or encryption algorithms stored in memory and executable by processor 622 to decrypt and/or encrypt data related to an access authentication process, e.g., using any suitable or known symmetric-key cryptography or shared secret encryption/decryption, asymmetric cryptography or public-key encryption/decryption, any encryption/decryption algorithms or protocols utilizing or based on hash functions, data encryption standard (DES), tripleDES, RC4, RC5, RC6, AES, digital certificates, or any other known or suitable applications or protocols. In some embodiments, decryption/encryption circuity 624 may utilize a shared key 630 (known by both authentication unit 612 and mobile access device 614) for decrypting and/or encrypting data. Wireless communication interfaces 626 may include any devices for wirelessly transmitting and/or receiving data, e.g., a distinct wireless transmitter and wireless receiver, or a combined wireless transceiver.

Environmental data criteria 627 may include any rules, criteria, or algorithms executable by processor 622 to evaluate environmental data received from mobile access device 614 (“MAD-side environmental data,” discussed below) to determine whether to authorize access to the vehicle, e.g., based on a determination of whether mobile access device 614 is within a defined range (distance) of the vehicle, whether mobile access device 614 is moving toward the vehicle, whether biometric or other person-specific environmental data collected buy mobile access device 614 matches corresponding environmental reference data 628 stored by vehicle-side authentication unit 612, etc. Environmental data criteria 627 may be embodied as algorithms, look-up table(s), or other computer instructions stored in a memory device of vehicle-side authentication unit 612.

In some embodiments, environmental data criteria 627 may specify rules for comparing environmental data received from mobile access device 614 (“MAD-side environmental data”) with environmental reference data 628 stored by vehicle-side authentication unit 612, e.g., instead of (or in additional to) comparing the environmental data from mobile access device 614 with vehicle-side environmental data. In such embodiments, vehicle-side authentication unit 612 may omit vehicle-side environmental sensors 620.

Environmental reference data 628 may include any reference data suitable for comparison with MAD-side environmental data received from mobile access device 614. For example, environmental reference data 628 may include fingerprint data, eye data, other biometric data, or other personal data associated with a user and detectable by mobile access device 614, as discussed below.

Mobile access device (“MAD”) 614 may include one or multiple MAD-side environmental sensors 640, one or more user interface devices 642, a processor 644, decryption/encryption unit circuitry 646, and wireless communication interfaces 648.

A MAD-side environmental sensor 640 may include any type of sensor, device, or system configured to collect or detect MAD-side environmental data. As used herein, “MAD-side environmental data” includes any data regarding one or more characteristic of the status or environment of mobile access device 612 and any data regarding one or more characteristic of a user of mobile access device 614. For example, MAD-side environmental sensors 640 may include any one or more of the following types of sensors, devices, or systems (and one or more instance of each type) configured to collect or detect any of the following types of MAD-side environmental data:
(a) a global positioning system (GPS) system or other geographic location system configured to determine geographic coordinates or other geographic location data regarding mobile access device 614,
(b) an altimeter configured to measure an altitude of mobile access device 614,
(c) a temperature sensor configured to measure local temperature data at mobile access device 614,
(d) a humidity sensor configured to measure local humidity data at mobile access device 614,
(e) a pressure sensor configured to measure local barometric pressure data at mobile access device 614,
(f) accelerometer(s) or other orientation sensor(s) configured to detect a physical orientation of mobile access device 614, a movement direction, movement speed, movement status (e.g., moving vs. stationary), or any other orientation or movement parameters,
(g) a fingerprint sensor configured to detect fingerprint data of a user of mobile access device 614;
(h) an eye sensor configured to detect information regarding a user's iris, retina, or other aspect of the eye;
(i) a facial recognition sensor configured to detect information regarding a user's face;
(j) other biometric sensor(s) configured to detect information regarding a biometric characteristic of the user of mobile access device 614; and/or
(k) any other type(s) of sensors, devices, or systems configured to detect or collect data regarding one or more characteristic of the status or environment of mobile access device 614 or and any data regarding one or more characteristic of a user of mobile access device 614.

User interface device(s) 642 may include any one or more devices or components configured to receive commands or other input from a user, e.g., one or more physical buttons, switches, capacitive sensors, etc. configured to receive input from a user.

Processor 644 may include a microprocessor, a microcontroller including a microprocessor, an application processor, a digital signal processor, or any other type of data processing device. Encryption/decryption unit 646 may include any known or suitable encryption and/or decryption algorithms stored in memory and executable by processor 644 to encrypt and/or decrypt data related to an access authentication process, e.g., using any suitable or known symmetric-key cryptography or shared secret encryption/decryption, asymmetric cryptography or public-key encryption/decryption, any encryption/decryption algorithms or protocols utilizing or based on hash functions, data encryption standard (DES), tripleDES, RC4, RC5, RC6, AES, digital certificates, or any other known or suitable applications or protocols. In some embodiments, encryption/decryption unit 646 may utilize the shared key 630 known by authentication unit 612 for decrypting and/or encrypting data. Wireless communication interfaces 648 may include any devices for wirelessly transmitting and/or receiving data, e.g., a distinct wireless transmitter and wireless receiver, or a combined wireless transceiver.

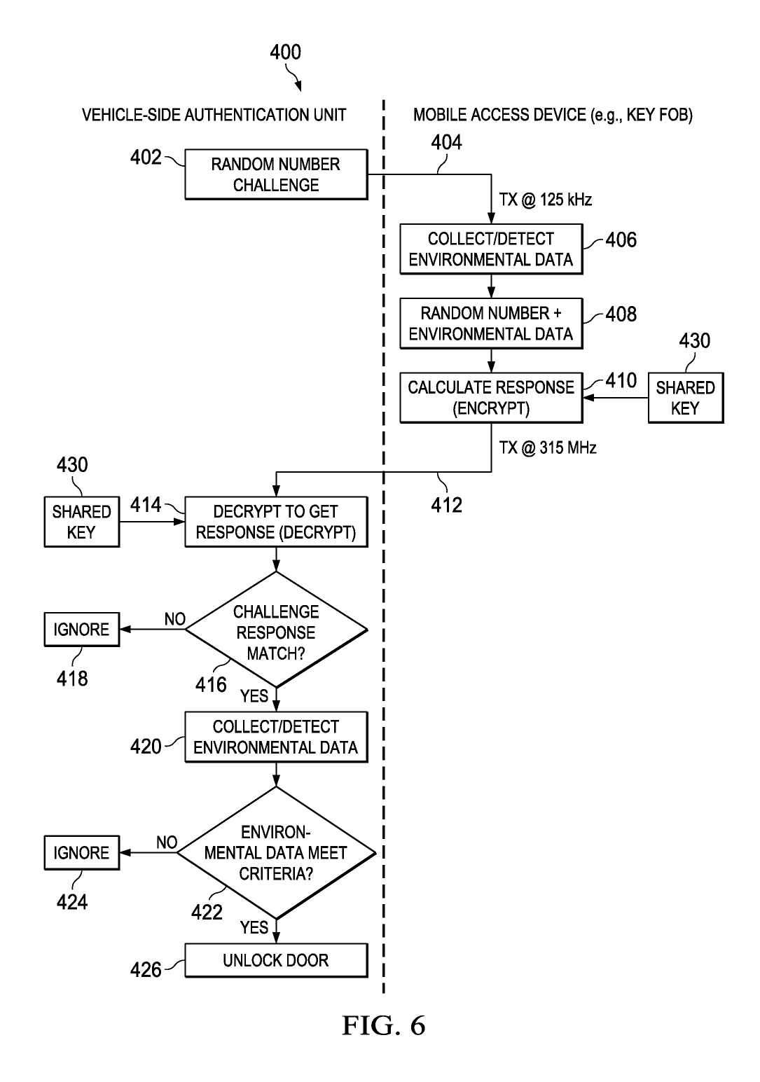

In operation, vehicle-side authentication unit 612 and mobile access device 614 may be configured to perform any operations for generating and authenticating an access request from mobile access device 614. For example, vehicle-side authentication unit 612 may be configured to generate and wirelessly transmit an authentication challenge (e.g., including a random number); mobile access device 614 may be configured to receive the authentication challenge, generate an encrypted challenge response that includes MAD-side environmental data collected by MAD-side environmental sensor(s) 620, and wirelessly transmit the encrypted challenge response; and vehicle-side authentication unit 612 may be further configured to receive and analyze the encrypted challenge response to authenticate the challenge response and determine whether to provide access to the vehicle. For example, e.g., as discussed below with respect to FIG. 6, vehicle-side authentication unit 612 may decrypt the encrypted challenge response from mobile access device 614, identify the MAD-side environmental data from the decrypted challenge response, and apply environmental data criteria 627 to analyze the MAD-side environmental data with respect to (a) vehicle-side environmental data collected by vehicle-side environmental sensor(s) 620, (b) environmental reference data 628 stored by authentication unit 612, and/or (c) any other reference data or criteria.

For example, in some embodiments, environmental data criteria 627 may require an exact match between MAD-side environmental data and corresponding vehicle-side environmental data or environmental reference data 628 in order to validate the mobile access device 614 and grant access to the vehicle. For example, environmental data criteria 627 may compare fingerprint data collected by mobile access device 614 with corresponding fingerprint data stored as environmental reference data 628, and validate the mobile access device 614 only if the data is an exact match.

As another example, environmental data criteria 627 may require a match to within a defined threshold range (e.g., less than 10% difference) between the evaluated MAD-side environmental data and corresponding vehicle-side environmental data and/or environmental reference data 628, in order to validate the mobile access device 614 and grant access to the vehicle. For example, environmental data criteria 627 may compare a MAD-side measured temperature with a vehicle-side measured temperature, and validate the mobile access device 614 only if the temperature difference is less than 3 degrees.

As another example, environmental data criteria 627 may be executable to calculate a distance or distance range between the mobile access device 614 and the vehicle, based on the received MAD-side environmental data and the corresponding vehicle-side environmental data and/or environmental reference data 628 (or based solely on the received MAD-side environmental data), and validate the mobile access device 614 only if the calculated distance or distance range is within a threshold distance or distance range. For example, environmental data criteria 627 may compare MAD-side location data (e.g., GPS data) with vehicle-side location data (e.g., GPS data), determine a distance between the mobile access device 614 and the vehicle, and validate the mobile access device 614 only if the distance is less than 10 feet, 25 feet, 50 feet, 100 feet, or any other threshold distance.

As another example, environmental data criteria 627 may be executable to determine a movement direction, speed, and/or movement status (e.g., moving vs. stationary) of mobile access device 614, based on the received MAD-side environmental data and the corresponding vehicle-side environmental data and/or environmental reference data 628 (or based solely on the received MAD-side environmental data), and validate the mobile access device 614 only if the mobile access device 614 is moving toward the vehicle (e.g., within a defined angular range) and/or moving at a speed within a defined range or above/below a respective speed threshold.

FIG. 6 is a flowchart of a first example process 400 for managing authentication-based access to a vehicle using sensor-based environmental data, according to one example embodiment. Process 400 may be executable by the relevant components of system 600 shown in FIG. 5 and discussed above.

At 402, authentication unit 612 may detect an access triggering event and generate an authentication challenge (e.g., including a random number or other unique information), and wirelessly transmit the authentication challenge at 404. The access triggering event could include a person touching a door handle or other part of the vehicle, a person pressing a button or other interface 642 on mobile access device 614 that causes the mobile access device 614 to transmit a wireless signal detectable by authentication unit 12, or authentication unit 12 wirelessly detecting a nearby presence of mobile access device 614 (e.g., using radio-frequency identification (RFID), near-field communication (NFC), or other communication technology), for example.

Mobile access device (e.g., key fob) 614 may wirelessly receive the authentication challenge, and initiate a response process. At 406, mobile access device 614 collects or detects MAD-side environmental data using one or more MAD-side environmental sensors 640. In some embodiments, mobile access device 614 may initiate measurement(s) or other data collection by environmental sensor(s) 640 in real-time in response to receiving the authentication challenge.

In other embodiments, mobile access device 614 may identify environmental data previously collected by environmental sensor(s) 640 and stored by mobile access device 614. For example, mobile access device 614 may control environmental sensor(s) 640 to collect/detect MAD-side environmental data at a defined frequency (e.g., every 10 seconds), store the most recently collected MAD-side environmental data (and/or one or more previous environmental data measurements), and access this most recently collected MAD-side environmental data (or an average or other mathematical function of multiple recently collected MAD-side environmental data) upon receiving the authentication challenge. This may allow the mobile access device 614 to generate and transmit a challenge response in real-time, and may thus reduce or eliminate delays associated with certain types of environmental sensor measurements (such as sensor measurements that require more than one second, for example).

At 408, mobile access device 614 may combine the MAD-side environmental data collected at 406 with the random number or other unique information included in the authentication challenge. At 410, mobile access device 614 may execute a suitable encryption algorithm 646 to encrypt the combined data using a shared key 430 to form an encrypted challenge response, and wirelessly transmit the encrypted challenge response at 412.

At 414, vehicle-side authentication unit 612 may wirelessly receive the encrypted challenge response and may execute a suitable decryption algorithm 624 to decrypt the challenge response using the shared key 430, to thereby identify the MAD-side environmental data and the random number or other unique information included in the challenge response. At 416, authentication unit 612 may determine whether the random number or other unique information identified from the challenge response matches the random number or other unique information included in the authentication challenge generated at 402. If the data do not match, authentication unit 612 may ignore the challenge response and/or output a notification indicating a failed access attempt at 418.

Alternatively, if the data do match, authentication unit 612 may analyze the MAD-side environmental data identified from the challenge response to determine whether to authenticate the response. At 420, authentication unit 612 may collect or detect vehicle-side environmental data using one or more vehicle-side environmental sensors 620. In some embodiments, authentication unit 612 may initiate measurement(s) or other data collection by environmental sensor(s) 620 in real-time in response to a positive data match at 416, or previously in response to receiving the challenge response at 414, or previously at the time of generating the authentication challenge at 402. In other embodiments, e.g., as discussed above regarding the collection of MAD-side environmental data by mobile access device 416, authentication unit 612 may collect vehicle-side environmental data at a defined frequency (e.g., every 10 seconds), store recently collected vehicle-side environmental data, and access this stored environmental data at step 420. This may allow the authentication unit 612 to evaluate and respond to the challenge response in real-time, and may thus reduce or eliminate delays associated with certain types of environmental sensor measurements (such as sensor measurements that require more than one second, for example).

At 422, authentication unit 612 may apply environmental data criteria 627 to the MAD-side environmental data identified from the challenge response at 414 with respect to (a) vehicle-side environmental data collected at 420, (b) environmental reference data 628 stored by authentication unit 612, and/or (c) any other reference data or criteria. If the MAD-side environmental data does not meet the relevant criteria 627, authentication unit 612 may ignore the challenge response and/or output a notification indicating a failed access attempt at 424.

Alternatively, if the MAD-side environmental data do meet the relevant criteria 627, authentication unit 612 may determine that the challenge response is authenticated, and thus generate a vehicle access command, e.g., an unlock command, to provide access to the vehicle at 426.

In one alternative embodiment, instead of collecting vehicle-side environmental data at 420 and comparing the MAD-side environmental data identified from the challenge response with sensor-collected vehicle-side environmental data, authentication unit 612 may omit the collection of vehicle-side environmental data and instead compare the MAD-side environmental data with environmental reference data 628 stored by authentication unit 612. This embodiment may apply, for example, where mobile access device 614 is configured to collect/detect fingerprint data, eye data, other biometric data, or other personal data associated with a user of mobile access device 614.

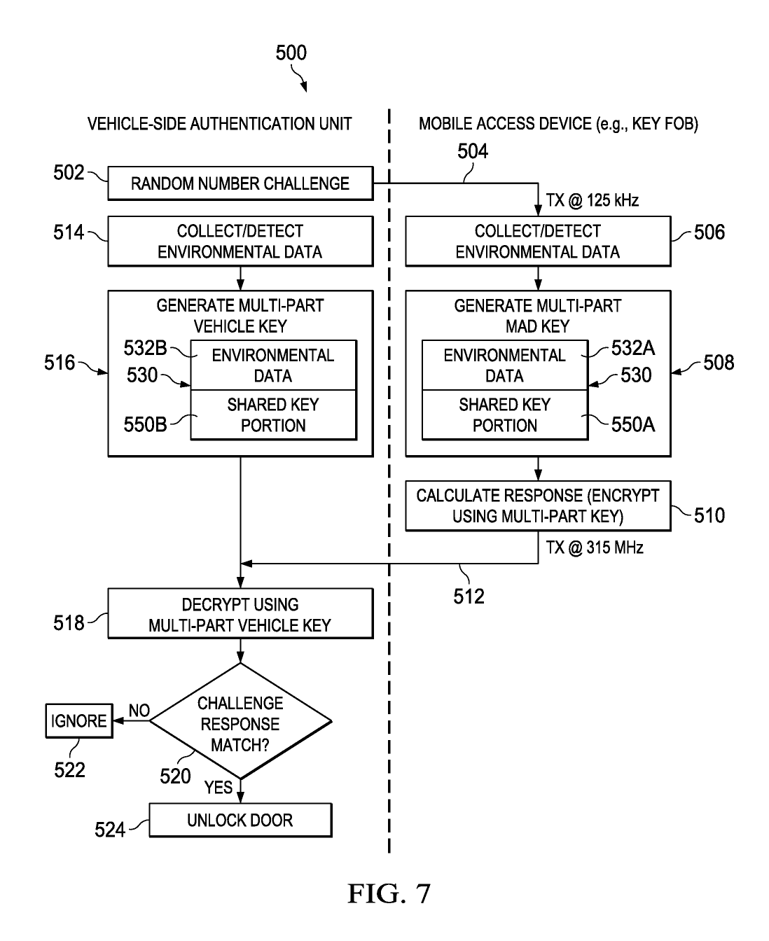

FIG. 7 is a flowchart of a second example process 500 for managing authentication-based access to a vehicle using sensor-based environmental data, according to another example embodiment. Process 500 may be executable by the relevant components of system 600 shown in FIG. 5 and discussed above. Whereas process 400 shown in FIG. 6 involves a challenge response that includes MAD-side environmental data (and a random number or other unique information from the authentication challenge) encrypted using a shared key, process 500 shown in FIG. 7 involves using MAD-side environmental data to encrypt a challenge response, as discussed below.

At 502, authentication unit 612 may detect an access triggering event and generate an authentication challenge (e.g., including a random number or other unique information), and wirelessly transmit the authentication challenge at 504. Mobile access device (e.g., key fob) 614 wirelessly receives the authentication challenge, and initiates a response process. At 506, mobile access device 614 collects or detects MAD-side environmental data using one or more MAD-side environmental sensors 640, e.g., by initiating sensor measurement(s) by environmental sensor(s) 640 in real-time in response to receiving the authentication challenge, or by accessing recently collected MAD-side environmental data (e.g., to reduce or eliminate delays associated with certain types of environmental sensor measurements), as discussed above regarding step 406 shown in FIG. 6.

At 508, mobile access device 614 may generate a multi-part MAD key 550A that includes (a) a shared key portion 530 including shared key data known by both mobile access device 614 and vehicle-side authentication unit 612 and (b) an environmental data portion 532A including MAD-side environmental data collected at 506 (or data generated from such MAD-side environmental data).

At 510, mobile access device 614 may calculate a challenge response by may executing a suitable encryption algorithm 646 to encrypt the random number or other unique information from the authentication challenge using the multi-part MAD key 550A, and wirelessly transmits the encrypted challenge response at 512.

In parallel with the operations of mobile access device 614 discussed above (or upon receiving the encrypted challenge response sent at 512), vehicle-side authentication unit 612 may generate its own multi-part key based on local environmental data. At 514, authentication unit 612 may collect or detect vehicle-side environmental data using one or more vehicle-side environmental sensors 620, e.g., by initiating sensor measurement(s) by environmental sensor(s) 620 in real-time in response to receiving the authentication challenge, or by accessing recently collected vehicle-side environmental data (e.g., to reduce or eliminate delays associated with certain types of environmental sensor measurements), as discussed above.

At 516, authentication unit 612 may generate a multi-part vehicle key 550B that includes (a) a shared key portion 530 including the shared key data known by mobile access device 614 and vehicle-side authentication unit 612 and (b) an environmental data portion 532B including vehicle-side environmental data collected at 514 (or data generated from such vehicle-side environmental data).

At 518, authentication unit 612 may wirelessly receive the encrypted challenge response transmitted by mobile access device 614 at 512, and may execute a suitable decryption algorithm 624 to decrypt the encrypted challenge response using the multi-part vehicle key 550B, to thereby identify the random number or other unique information included in the challenge response. At 520, authentication unit 612 may determine whether the random number or other unique information identified from the challenge response matches the random number or other unique information included in the authentication challenge generated at 502. If the data do not match, authentication unit 612 may ignore the challenge response and/or output a notification indicating a failed access attempt at 522. Alternatively, if the data do match, authentication unit 612 may determine that the challenge response is authenticated, and thus generate a vehicle access command, e.g., an unlock command, to provide access to the vehicle at 524.

1. A system for controlling access to an object, comprising:
a mobile access device including:
at least one first environmental sensor configured to collect first environmental data associated with the mobile access device;
a first processor configured to generate an access request message including the first environmental data collected by the at least one first environmental sensor; and
a wireless transmitter configured to wirelessly transmit the access request message;
an authentication unit associated with the object and including:
a wireless receiver configured to receive the access request message from the mobile access device; and
a second processor configured to determine whether to grant access to the object based at least on the first environmental data included in the access request message.

2. The system of claim 1, wherein:
the authentication unit associated with the object includes at least one second environmental sensor configured to collect second environmental data associated with the object; and
the second processor is configured to determine whether to grant access to the object based at least on (a) the first environmental data included in the access request message and (b) the second environmental data collected by the at least one second environmental sensor associated with the authentication unit.

3. The system of claim 1, wherein:
the mobile access device includes an encryption unit configured to encrypt the access request message;
the authentication unit includes a decryption unit configured to decrypt the encrypted access request message from the mobile access device.

4. The system of claim 1, wherein:
the mobile access device is configured to wirelessly receive an authentication challenge from the authentication unit;
the access request message generated by the first processor of the mobile access device includes (a) a response to the authentication challenge and (b) the first environmental data.

5. The system of claim 1, wherein:
the authentication unit includes at least one second environmental sensor configured to collect second environmental data associated with the object; and
determining whether the first environmental data meets the one or more predefined environmental criteria comprises comparing the first environmental data identified from the decrypted access request message with the second environmental data.

6. The system of claim 1, wherein the second processor of the authentication unit is configured to:
determine a distance between the mobile access device and the object based at least on the first environmental data included in the access request message; and
determine whether to grant access to the object based on the determined distance between the mobile access device and the object.

7. The system of claim 1, wherein:
the mobile access device is configured to wirelessly receive an authentication challenge transmitted by the authentication unit; and
the first processor of the mobile access is configured to:
combine challenge information contained in the authentication challenge with the first environmental data;
encrypt the combined information using a shared key that is shared by the mobile access device and the authentication unit; and
generate the access request message including the encrypted combined information.

8. The system of claim 7, wherein the second processor of the authentication unit is configured to:
decrypt the encrypted access request message using the shared key;
identify the challenge information and the first environmental data from the decrypted access request message;
perform the authentication analysis by:
determining whether the first environmental data identified from the decrypted access request message meets one or more predefined environmental criteria;
comparing the challenge information identified from the decrypted access request message with the authentication challenge; and
determining to grant access to the object only if (a) the first environmental data meets the one or more predefined environmental criteria and (b) the challenge information identified from the decrypted access request message matches the authentication challenge.

9. The system of claim 1, wherein:
the mobile access device is configured to wirelessly receive an authentication challenge transmitted by the authentication unit; and
the first processor of the mobile access is configured to:
generate a first multi-part key including a first shared key portion and a first environmental data portion, wherein the first shared key portion includes shared data that is shared by the mobile access device and the authentication unit, and the first environmental data portion includes or is generated based on the first environmental data;
use the first multi-part key to encrypt challenge information contained in the authentication challenge; and
generate the access request message including the encrypted challenge information.

10. The system of claim 9, wherein the second processor of the authentication unit is configured to:
generate a second multi-part key including a second shared key portion and a second environmental data portion, wherein the second shared key portion includes the shared data, and the second environmental data portion includes or is generated based on the second environmental data;
use the second multi-part key to decrypt the encrypted access request message;
identify the challenge information from the decrypted access request message;
determine whether the challenge information identified from the decrypted access request message matches the authentication challenge; and
grant access to the object only if the challenge information identified from the decrypted access request message matches the authentication challenge.

11. The system of claim 1, wherein the authentication analysis performed by the second processor of the authentication unit comprises:
identifying the first environmental data from the access request message; and
comparing the first environmental data identified from the access request message with the second environmental data collected by the at least one second environmental sensor associated with the authentication unit.

12. The system of claim 1, wherein the at least one first environmental sensor associated with the mobile access device includes at least one of the following types of sensors:
a global positioning system (GPS) system configured to determine a location of the mobile access device,
an altimeter configured to measure an altitude of the mobile access device,
a temperature sensor configured to measure local temperature data,
a humidity sensor configured to measure local humidity data,
a pressure sensor configured to measure local barometric pressure data,
an accelerometer or other orientation sensor configured to detect a physical orientation of the mobile access device,
a fingerprint sensor configured to detect fingerprint data of a user touching the mobile access device;
an eye sensor configured to detect information regarding the user's iris, retina, or other aspect of the eye;
a facial recognition sensor configured to detect information regarding the user's face; or
one or more other biometric sensor configured to detect information regarding a biometric characteristic of the user.

13. The system of claim 12, wherein the authentication unit associated with the object includes at least one second environmental sensor of the same type or types of sensors as the at least one first environmental sensor associated with the mobile access device.

14. The system of claim 1, wherein the object comprises a vehicle, and the mobile access device comprises a key fob or other handheld device.

15. The system of claim 1, wherein the first processor generating an access request message including the first environmental data comprises the first processor using the first environmental data for encrypting a challenge response or other data of the access request message.

16. An authentication system for controlling access to an object, comprising:
a wireless transmitter configured to transmit an authentication challenge;
a wireless receiver configured to receive a challenge response from a mobile access device;
a processor configured to:
generate the authentication challenge, and cause the wireless transmitter to transmit the authentication challenge;
receive the challenge response from the mobile access device via the wireless receiver, the challenge response including second environmental data associated with the mobile access device;
determining whether the first environmental data included in the access request message meets one or more predefined environmental criteria;
determine whether to grant access to the object based at least on whether the first environmental data meets the one or more predefined environmental criteria.

17. The authentication system of claim 16, further comprising at least one environmental sensor configured to collect first environmental data associated with the object; and
wherein the processor is configured to:
compare the first environmental data included in the access request message with the second environmental data collected by the at least one environmental sensor of an authentication unit;
determine to grant access to the object only if the first environmental data matches the second environmental data within a specified range.

18. A method for controlling access to an object, comprising:
generating, by a processor of the authentication unit, an authentication challenge;
transmitting the authentication challenge via a wireless transmitter of the authentication unit;
receiving, via a wireless receiver of the authentication unit, a challenge response from a mobile access device, the challenge response including second environmental data associated with the mobile access device;
determining whether to grant access to the object based at least on the first environmental data included in the access request message.

19. The method of claim 18, further comprising:
collecting, by at least one environmental sensor of an authentication unit, first environmental data associated with the object;
comparing, by the processor of the authentication unit, the first environmental data included in the access request message with the second environmental data collected by the at least one environmental sensor of an authentication unit;
determine to grant access to the object only if the first environmental data matches the second environmental data.

20. The method of claim 18, comprising:
determining a distance between the mobile access device and the object based at least on the first environmental data included in the access request message; and
determining whether to grant access to the object based on the determined distance between the mobile access device and the object.
